(19) United States
(12) Patent Application Publication
(10) Pub. No.: US 2005/0178669 A1
(43) Pub. Date: Aug. 18, 2005

(54) Method of electroplating aluminum

(76) Inventor: John L. Strubbe, Round Rock, TX (US)

Correspondence Address: TYCO ELECTRONICS CORPORATION, MAIL STOP R20/2B, 307 CONSTITUTION DRIVE, MENLO PARK, CA, 94025, US

(21) Appl. No.: 11/060,019

(22) Filed: Feb. 16, 2005

Related U.S. Application Data
(60) Provisional application No. 60/545,574, filed on Feb. 17, 2004.

(51) Int. Cl. B05D 5/12; C25D 5/44

(52) U.S. Cl. 205/185; 427/96.1; 205/213

(57) ABSTRACT

This invention is a zincating process of aluminum surfaces for subsequent plating in which the aluminum surfaces are cleaned, contacted with an acidic etching solution comprising a peroxygen compound, the acidic etching solution being substantially free of corrosive nitrate compounds, and contacting the aluminum surfaces with a zincate solution containing 6-60 g/l zinc and 100-500 g/l hydroxide ion. The acidic etching solution is substantially free of toxic inorganic fluoride compounds in order to simplify waste treatment. This invention may be understood with reference to FIG. 2, in particular Step 6.

### CROSS-REFERENCE TO RELATED APPLICATIONS

This application is an application under 35 USC 111(a) and claims priority under 35 USC 119 from Provisional Application Ser. No. 60/545,574, filed Feb. 17, 2004 under 35 USC 111 (b). The disclosure of that provisional application is incorporated herein by reference.

### BACKGROUND OF THE INVENTION

1. Field of the Invention

This invention is in the field of electroplating on aluminum. More specifically it relates to zincating methods, and in particular to methods of forming plated-through holes in multilayer printed wiring boards having aluminum core internal ground planes.

2. Introduction to the Invention

The metal plating process for aluminum requires a lengthy and costly pretreatment process to prepare the aluminum for plating. The most popular method of applying plating is the zincate method which applies an immersion coating of zinc on a clean aluminum surface. In a typical metal plating on aluminum process, the aluminum substrate is first cleaned to remove dirt, grease and oils and then etched to provide a substrate suitable for adhesion of a zincate coating. The etched substrate is then desmutted with nitric acid to remove surface aluminum oxide, and the aluminum substrate is then zincated followed by metal plating. The zincate layer is a fugitive coating that disappears in the subsequent metal plating operation. A double zincate procedure is typically used wherein a first zincate layer is stripped using nitric acid, and then a second zincate layer is applied to the aluminum substrate. The double zincate process applies the first zinc coating followed by immersion in 50% nitric acid to strip the zinc. Then the second zinc coating is applied which is much more uniform than the first. The nitric acid used for desmutting aluminum and for the double zincate process would aggressively etch copper, so that conventional zincate processes cannot be used for manufacturing printed wiring boards.

The standard zincating process starts with a two step alkaline etch of an aluminum surface, 1-3 minutes at 77° C. (170° F.) in a buffered alkaline cleaning solution, and then 0.50-1 minute at 55° C. (130° F.) in a sodium hydroxide etch solution. The alkaline etch leaves a smut on the aluminum which is removed by strong acids, such as 50% nitric acid solution, or a 25% hot sulfuric acid followed by 50% nitric acid solution or a solution of 3 parts nitric acid and 1 part hydrofluoric acid. After desmutting, an aluminum surface is coated with zinc by immersion in a zincate solution. Zincate solutions typically contain 120-500 g/l sodium hydroxide, 20-100 g/l zinc oxide, 10-60 g/l Rochelle salt (potassium sodium tartrate) or other complexing organic acid salts such as gluconates and salicylates and additives such as sodium nitrate, copper, iron or nickel salts.

Printed wiring boards with high component density per unit area require a means of dissipating heat. The problem increases in complexity as the semiconductor industry puts more electronic processing and functionality into smaller packages. One of the most important problems is pulling the heat away from the components and the printed wiring board and maintaining a reliable connection between the components and the printed wiring board. The two most common approaches are the external passive heatsink and the internal active heatsink.

The external passive heatsink is a metal plate bonded to the external layer of the printed wiring board. The metal plate is either aluminum or copper. The heat dissipation is dependent on the heatsink material, thickness of the material and the thermal dissipation properties of the bonding material between the heatsink and the printed wiring board. External passive heatsink planes require designs with a low density of plated-through holes, which is a major disadvantage.

Internal active heatsink planes may function both as a ground plane and a heatsink. The copper plates that are used as internal ground planes and heatsinks can be easily laminated, drilled and plated within printed wiring boards to offer dual support for electrical and thermal needs. However, the thick copper plates required for adequate thermal dissipation are heavy, and are of limited use in weight sensitive applications.

U.S. Pat. No. 4,601,916 (Arachtingi), the disclosure of which is incorporated herein by reference, describes an aluminum core printed wiring board. The aluminum core is laminated on both sides with copper clad prepreg. Holes are drilled through the copper cladding and the aluminum core. The aluminum surface exposed on the walls of the holes is electrophoretically coated with an epoxy resin, and a printed wiring pattern and plated-through holes formed by conventional techniques. The aluminum core is a passive support, since there is no way in the procedure of Arachtingi to make a plated-through hole that has an electrical connection to the aluminum core.

U.S. Pat. No. 5,538,616 (Arai), the disclosure of which is incorporated herein by reference, concerns a process to produce printed wiring boards, such as a multilayer printed wiring board with an internal aluminum conductor, the aluminum conductor being connected by a plated-through hole. In the Arai process a multilayer laminate provided with through holes is treated with a palladium/tin catalyst. Then the laminate is subjected to alkali and acid cleaning solutions to etch the exposed aluminum surface. Following the acid cleaning solution the laminate is treated with a hot, acidic solution containing nickel nitrate and sodium nitrate. Arai proposes that this hot, acidic nickel nitrate treatment causes the surface of the aluminum to be substituted with fine nickel at submicron intervals. This nickel is a base for further growth by electroless nickel plating. After electroless nickel plating the through holes are plated by conventional copper electroplating.

The acidic cleaning solution of Arai is 20% nitric acid and 50 g/l ammonium bifluoride. The nickel substituent treatment is also an acidic nitric treatment. Nitric acid solutions strongly attack copper surfaces, such as copper clad laminates, etching and pitting the copper surface and generating fumes of the noxious oxides of nitrogen. Arai does not show masking the copper surfaces before electroless nickel plating. Unless these surfaces are masked before electroless nickel deposition, the external copper surfaces would be plated with electroless nickel. Masking and subsequently stripping the masks would add extra steps to the process. If the external copper surfaces are not masked, the surface conductor patterns must be etched through an electroless nickel layer. Etching through electroless nickel in fine patterns, as is required in multilayer printed wiring boards, is extremely difficult because of the strong etchants needed to attack the nickel layer and the corrosion cell set up between the nickel and copper layers. The acidic fluoride solutions, such as ammonium bifluoride are very toxic, and special precautions must be taken in their use and in treating waste solutions containing them. For these reasons, the process of Arai has not gained acceptance in the printed wiring industry.

### BRIEF SUMMARY OF THE INVENTION

An object of this invention is to provide a process for zincating an aluminum substrate; the process avoiding the use of nitric acid and acidic fluorides which are environmentally unfriendly, and may be difficult to waste-treat.

This invention is a zincating process of aluminum surfaces for subsequent plating in which the aluminum surfaces are cleaned, contacted with an acidic etching solution comprising a peroxygen compound, the acidic etching solution being substantially free of corrosive nitrate compounds, and contacting the aluminum surfaces with a zincate solution containing 6-60 g/l zinc and 100-500 g/l hydroxide ion. The acidic etching solution may be substantially free of toxic inorganic fluoride compounds in order to simplify waste treatment.

In one aspect the invention is a method of manufacturing a printed wiring board on an organic laminate, the printed wiring board having an aluminum conductor layer and copper plated-though holes. The method comprises providing a laminate having at least one aluminum conductor and holes that contact the aluminum conductor; cleaning the walls of the holes and the exposed aluminum conductor; contacting the walls of the holes and the exposed aluminum conductor with an acidic etching solution, the acidic etching solution being substantially free of corrosive nitrates; contacting the exposed aluminum conductor with a zincate solution, the zincate solution containing 6-60 g/l zinc and 100-500 g/l hydroxide ion; electroplating the exposed aluminum conductor with copper in an alkaline plating solution; metallizing the walls of the holes; electroplating the hole walls to form copper plated-through holes, and processing the laminate having copper plated-though holes to form a finished printed wiring board.

### BRIEF DESCRIPTION OF THE DRAWINGS

The invention is illustrated by the drawings in which FIG. 1 is a chart of the overall process flow for manufacturing multilayer printed wiring boards according to the invention.

FIG. 2 is a diagram displaying the process flow for zincating and copper plating on aluminum substrates.

FIG. 3 is a schematic cross section of a plated-through hole in a multilayer printed wiring board having an aluminum ground plane.

### DETAILED DESCRIPTION OF THE INVENTION

The zincating process according to this inventions starts with an etch of an aluminum surface in an alkaline cleaning solution followed by either a short etch in a sodium hydroxide etch solution, or an acidic cleaning solution. These treatments leave a smut on the aluminum surface which is stripped in a non-nitric acid stripper solution. The non-nitric stripper is an aqueous solution of a peroxygen compound such as persulfates or peroxysulfates. One such stripper is 25 g/l of potassium peroxymonosulfate. Potassium peroxymonosulfate is available from DuPont as Oxone™ and Degussa Corp., Parsippany, N.J. as Caroat™. The stripper or etch solution is followed by a rinse.

A potassium peroxymonosulfate stripper typically contains 10 to 100 g/l of potassium peroxymonosulfate; the preferred concentration is 20 to 30 g/l. After desmutting an aluminum surface is coated with zinc by immersion in a zincate solution. Zincate solutions typically contain 120-500 g/l sodium hydroxide, 20-100 g/l zinc oxide, 10-60 g/l Rochelle salt (potassium sodium tartrate) or other complexing organic acid salts such as gluconates and salicylates and additives such as sodium nitrate, copper, iron or nickel salts.

The product and the methods of manufacturing the product of the invention are applicable to simple double-sided printed wiring boards and printed wiring boards with at least one aluminum conductor layer or having an aluminum core. However the invention is especially suitable for high density multilayer wiring boards with a plurality of signal layers and one or more aluminum heatsink and/or ground planes.

In the manufacture of a multilayer board having an aluminum ground plane, the internal signal planes are prepared in the conventional manner by etching the desired pattern on copper clad substrate. The signal planes and the outer copper clad layers are laminated to the aluminum ground plane in the same manner as is used when laminating to a copper ground plane. After lamination, the required through holes are drilled through the outer copper clad layers, the signal layers and the aluminum ground plane. Any required blind vias are also drilled.

In order to form plated-through holes with an aluminum heatsink/ground plane it is necessary to electroplate on the aluminum as well as the copper conductors and the insulating dielectric between the conductor layers.

A process for producing aluminum core multilayer is outlined in FIG. 1. A kit of etched inner conductor layers, prepregs, the aluminum layer and external copper clad layers is assembled and laminated together. The multilayer laminate is drilled for through holes.

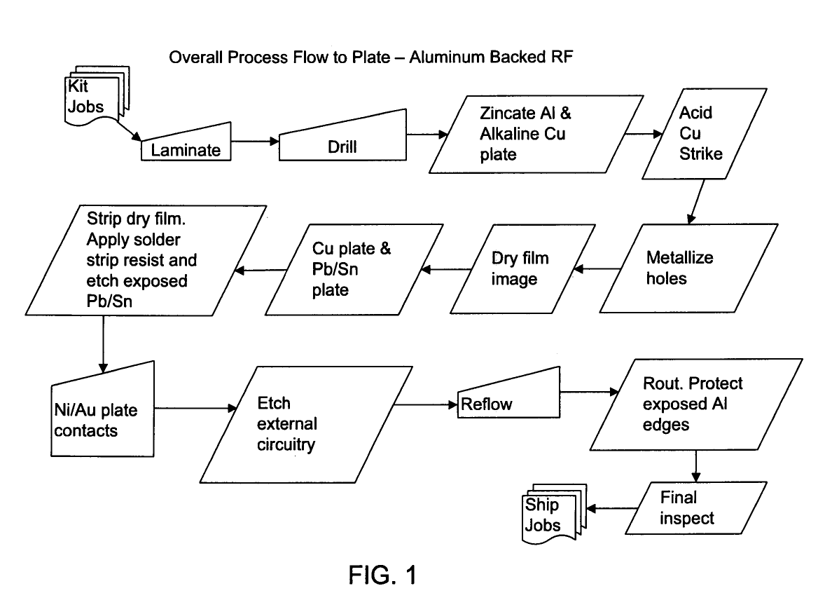

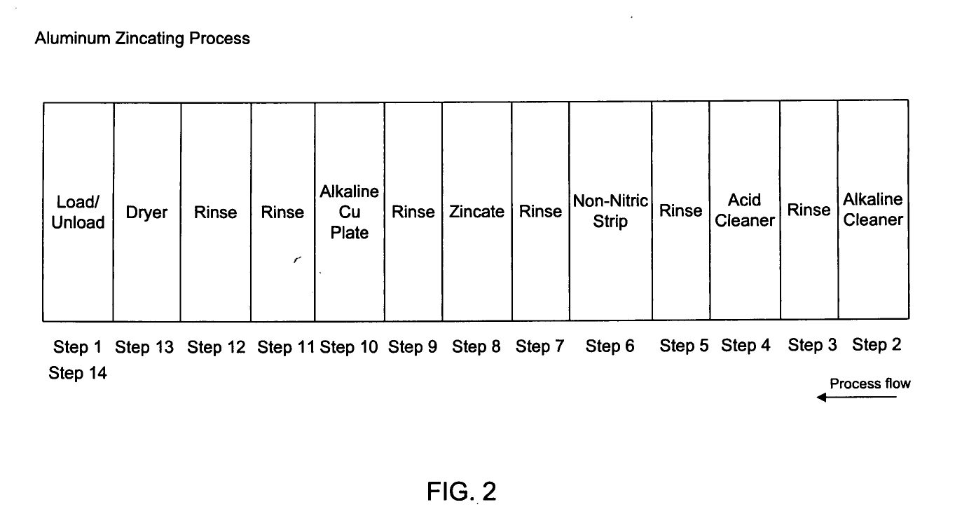

After drilling the through holes are prepared for plating as shown in FIG. 2. In the first step the multilayer panels are loaded into racks for plating. Step 2 is immersion in an alkaline cleaning solution. The alkaline cleaner solution may be agitated by means of a recirculating pump. Suitable alkaline cleaning solutions are well known and widely available; one such solution contains Atotech Basiclean LP™ at a concentration of 35-45 g/l at a temperature of 55° C. (130° F.). The Atotech™ products are available from Atotech USA Inc., 1750 Overview Drive, Rock Hill, S.C. Following a rinse, Step 3, the multilayer panels are immersed in an acid cleaner solution, FIG. 2, Step 4. One suitable acid cleaner is Atotech Acid Cleaner AFT, at a concentration of 145-225 g/l and a temperature of 43° C. (110° F.). Step 5 is a rinse; the rinse may be air agitated. Step 6 is a non-nitric acid stripper solution. The non-nitric stripper can be operated at room temperature and agitated by a recirculating pump. The non-nitric stripper is an aqueous solution of a peroxy compound such as persulfates or peroxysulfates. One such stripper is 25 g/l of potassium peroxymonosulfate. Potassium peroxymonosulfate is available from DuPont as Oxone™ and from Degussa Corp., Parsippany, N.J. as Caroat™. The stripper or etch solution is followed by a rinse, which may be air agitated, FIG. 2, Step 7.

A potassium peroxymonosulfate stripper typically contains 10 to 100 g/l of potassium peroxymonosulfate; the preferred concentration is 20 to 30 g/l. The copper concentration in the stripper will increase over time. The stripper is less effective when the copper concentration is greater than 4 g/l, and preferably the copper concentration is controlled to less than 3 g/l.

FIG. 2, Step 8 is the zincating solution. An artisan practicing this invention will select a zincating solution suitable for use on aluminum surfaces that have been treated with a desmutting solution that is substantially free of nitric and/or hydrofluoric acids. The artisan will also select a zincating solution that applies an adequate zinc coating without use of a “double zincate” process that uses a nitric acid stripper. Although a “double zincate” process with a non-nitric acid stripper may be used, a single zincate process is preferred. The zincating solution may be selected from among those available from the commercial suppliers to the metal finishing industry. The preferred zincate solutions contain 5-50 g/l zinc oxide, 50-125 g/l hydroxide ion. More preferred zincate solutions contain 6-15 g/l zinc oxide, 55-80 g/l hydroxide ion. A suitable commercially available zincate solution is Optibond™ A & B from Taskem, Inc., 4639 Van Epps Rd, Brooklyn Heights, Ohio. The Optibond solution may be used at 32-38° C. (90-100° F.) with zinc oxide and sodium hydroxide concentrations of 6-12 g/l and 110-160 g/l, respectively, and mixed by a recirculating pump.

As shown in FIG. 2, Step 8, the zincate step is followed by a rinse (Step 9) and then in Step 10 the zincated aluminum is electroplated in an alkaline copper plating bath. The preferred alkaline copper plating bath is a copper cyanide bath. Copper cyanide plating baths contain 30-75 g/l copper cyanide, 50-100 g/l sodium cyanide (or 60-120 g/l potassium cyanide), 30-60 g/l sodium carbonate (or potassium carbonate) and 30-100 g/l Rochelle salts. A good alkaline copper strike formulation is 40 g/l copper cyanide, 90 g/l sodium cyanide, 25 g/l sodium carbonate and 80 g/l Rochelle salts. This copper strike bath may be used at a temperature of 60° C. (140° F.) and a current density of 1.3 A/dm² (12 A/ft²). The copper deposit from the strike bath should be 2-5 μm (0.1-0.2 mil) thick. As shown in FIG. 2, the alkaline copper strike is followed by rinses, drying, and unracking, Steps 11, 12, 13 and 14. Step 11 is normally a dragout or non-circulating rinse. Step 12 should be a running rinse operating at room temperature. Optionally, after Step 12, the alkaline copper strike can be reinforced by an acid copper strike as shown in FIG. 1. Bright acid copper plating solutions are commonly used in the printed wiring board industry. One such bright acid copper plating bath is Atotech BLCT from Atotech USA Inc., 1750 Overview Drive, Rock Hill, S.C., is used. The strike deposit from the bright acid copper bath may also be 2-5 μm (0.1-0.2 mil) thick.

The multilayer printed wiring board now undergoes the conventional multilayer printed wiring processing, as shown in FIG. 1. Metallization of the dielectric layers of the through holes for through hole conductivity may be accomplished by a graphite treatment, catalyzing and electroless copper plating, or direct plating on a palladium treated surface, as per U.S. Pat. No. 4,683,036 (Morrissey et al.), the disclosure of which is incorporated herein by reference. After the through holes are metallized, the circuit image patterns are formed on the external copper layers with a dry film resist. The through holes and the external circuit pattern are electrolytically plated with bright acid copper and followed by electrolytic solder plating. A selective etch resist then is applied over the external circuit patterns leaving exposed the contact areas. The tin/lead plate is stripped from the contact areas. After the tin/lead plate is removed, the contact areas are plated with nickel and gold. Exposed areas and edges of the aluminum base optionally may also be plated with nickel or nickel and gold. The resist is stripped and the external copper layers are etched to form the surface conductors. The preferred etchant is the ammonical copper etchant commonly used in the printed wiring board industry. The solder plated surfaces are fused to reflow the tin/lead plate to a smooth, bright finish. The multilayer boards are cut to size; the exposed aluminum protected, by a Chemcoat or gold brush plating, and given the final inspection.

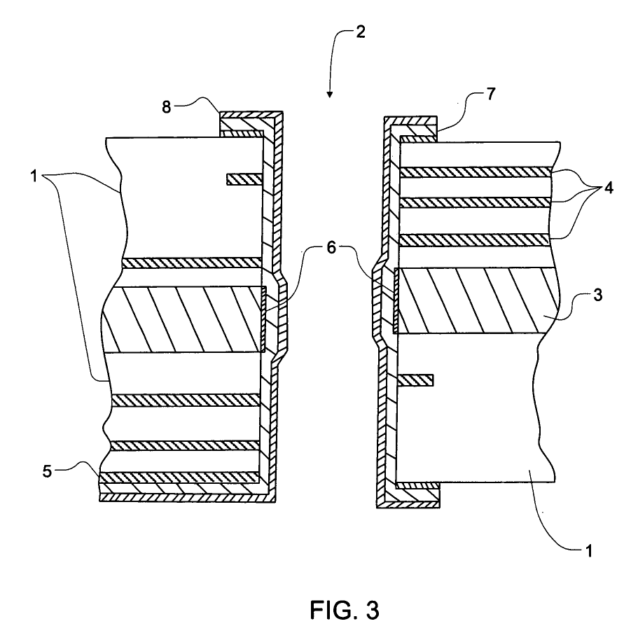

FIG. 3 illustrates a cross section of an aluminum core plated-through hole in a multilayer printed wiring board, with the through hole copper plating firmly bonded to the aluminum layer. In FIG. 3, the epoxy dielectric of the multilayer laminate is designated as 1; the through hole is 2. 3 designates the aluminum layer, and 4 are copper conductors on the internal layers. The etched copper conductive pattern on the external layer is marked as 5, while the copper deposited from an alkaline copper strike bath is shown as 6. The copper through hole plating is marked as 7, and the solder plating is shown as 8.

Multilayer printed wiring boards with an internal aluminum conductor layer may also be manufactured using an electroless nickel strike in lieu of the alkaline copper plate (FIG. 2, Step 10). The walls of the through hole are cleaned, and the exposed aluminum is treated with a non-nitric strip solution (FIG. 2, Step 6); rinsed; treated with a zincate solution (FIG. 2, Step 8); rinsed and then plated with electroless nickel. Since copper metal is not catalytic for electroless nickel plating, the external copper layers are not plated with nickel. If necessary, to insure against accidental activation of the external copper layers, the layers can be coated a mask or given a positive electrical bias to prevent nickel deposition. Conventional processing is followed after the electroless nickel strike to produce the finished multilayer printed wiring board.

The multilayer printed wiring board can also be produced with blind vias, with copper only or other metal surfaces by suitable modifications of the process. These modifications are well known to those skilled in the art.

1. A method of zincating aluminum surfaces for subsequent plating comprising
cleaning the aluminum surfaces;
contacting the aluminum surfaces with an acidic etching solution comprising a peroxygen compound, the acidic etching solution being substantially free of corrosive nitrate compounds; and
contacting the aluminum surfaces with a zincate solution, the zincate solution containing 6-60 g/l zinc and 100-500 g/l hydroxide ion.

2. The method of claim 1, wherein the acidic etching solution is substantially free of inorganic fluoride compounds.

3. The method of claim 1, wherein the peroxygen compound is selected from a group consisting of peroxydisulfuric acid, peroxysulfuric acid, peroxydisulfuric acid salts and peroxysulfuric acid salts.

4. The method of claim 3, wherein the peroxygen compound is sodium persulfate.

5. The method of claim 3, wherein the peroxygen compound is potassium monopersulfate.

6. The method of claim 1, wherein the zincate solution contains 5-50 g/l zinc oxide and 50-125 g/l hydroxide ion.

7. The method of claim 6 wherein the zincate solution contains 6-15 g/l zinc oxide and 55-80 g/l hydroxide ion.

8. The method of claim 1 wherein the aluminum surfaces are part of a multilayer printed wiring board on an organic laminate printed wiring board having at least one aluminum conductor layer.

9. The method of manufacturing a printed wiring board having an aluminum conductor layer according to claim 8, comprising:
providing a laminate having at least one aluminum conductor and holes that contact the aluminum conductor;
cleaning the walls of the holes and the exposed aluminum conductor;
contacting the walls of the holes and the exposed aluminum conductor with an acidic etching solution, the acidic etching solution being substantially free of corrosive nitrates;
contacting the exposed aluminum conductor with a zincate solution, the zincate solution containing 6-60 g/l zinc and 100-500 g/l hydroxide ion;
electroplating the aluminum with copper in an alkaline plating solution;
metallizing the walls of the holes;
electroplating the hole walls to form copper plated-through holes; and
processing the laminate having copper plated-though holes to form a finished printed wiring board.

10. The method of claim 9, wherein cleaning the hole walls and the exposed aluminum conductor comprises contacting with an alkaline cleaner solution.

11. The method of claim 10, wherein cleaning the hole walls and the exposed aluminum conductor further comprises contacting with an acid cleaner solution.

12. The method of claim 9, wherein the alkaline plating solution comprises a copper cyanide plating bath.

13. The method of claim 9, wherein the hole walls are electroplated with a layer of copper from an acidic copper sulfate plating bath to form copper plated-through holes.

14. The method of manufacturing a printed wiring board having an aluminum conductor layer according to claim 9, comprising:
providing a laminate having at least one aluminum conductor and holes that contact the aluminum conductor;
cleaning the walls of the holes and the exposed aluminum conductor;
contacting the walls of the holes and the exposed aluminum conductor with an acidic etching solution, the acidic etching solution being substantially free of corrosive nitrates;
contacting the exposed aluminum conductor with a zincate solution, the zincate solution containing 6-60 g/l zinc and 100-500 g/l hydroxide ion;
plating the exposed aluminum conductor with nickel in an electroless nickel plating solution;
metallizing the walls of the holes;
electroplating the hole walls to form copper plated-through holes; and
processing the laminate having copper plated-though holes to form a finished printed wiring board.
